(19) United States
(12) Patent Application Publication
(10) Pub. No.: US 2023/0372941 A1
(43) Pub. Date: Nov. 23, 2023

(54) MODULAR AND RAPID PCR DEVICE

(71) Applicants: BAHCESEHIR UNIVERSITESI, Istanbul (TR); MARMARA UNIVERSITESI REKTORLUGU OZEL KALEM BIRIMI, Istanbul (TR)

(72) Inventors: Mehmet Can ALPHAN, Istanbul (TR); Ibrahim Ertugrul YALCIN, Istanbul (TR); Lutfi ARDA, Istanbul (TR); Ibrahim Ilker OZYIGIT, Istanbul (TR)

(73) Assignees: BAHCESEHIR UNIVERSITESI, Istanbul (TR); MARMARA UNIVERSITESI REKTORLUGU OZEL KALEM BIRIMI, Istanbul (TR)

(21) Appl. No.: 18/029,116

(22) PCT Filed: Aug. 24, 2021
(86) PCT No.: PCT/TR2021/050853

§ 371 Date: Mar. 29, 2023

(30) Foreign Application Priority Data
Sep. 30, 2020 (TR) 2020/15580

(51) Int. Cl. B01L 3/00; B01L 7/00

(52) U.S. Cl. CPC B01L 3/50851; B01L 7/5255; B01L 2300/1805; B01L 2300/087; B01L 2300/0609

(57) ABSTRACT

A PCR device having a heating mechanism to subject samples to denaturation, annealing and extension processes is disclosed. The PCR device has a heating unit carrier having at least one first heating unit which provides heating of a first heating region at a first temperature for the denaturation process, at least one second heating unit which provides heating of a second heating region at a second temperature for the annealing process, at least one third heating unit which provides heating of a third heating region at a third temperature for the extension process; where the first heating unit, the second heating unit and the third heating unit are arranged in a first circular axis

### CROSS REFERENCE TO THE RELATED APPLICATIONS

This application is the national stage entry of International Application No. PCT/TR2021/050853, filed on Aug. 24, 2021, which is based on and claims priority to Turkish Patent Application Nos. 2020/15580, filed Sep. 30, 2020, the entire contents of which are incorporated herein by reference.

### TECHNICAL FIELD

The present invention relates to a new design for heating of samples and for providing amplification in shorter time when compared with PCR devices used presently and for using the device in different equipment thanks to the modular structure, in order to provide subjecting of samples to denaturation, annealing and extension processes in PCR (polymerase chain reaction) devices.

### BACKGROUND

Studies in the field of molecular biology and bio-engineering are rapidly increasing worldwide. In molecular biology studies, amplifying of the specific DNA and RNA parts by isolation and presence of specific gene parts in the target living being and the detection of the amount are among the most important components of these studies. In these studies, PCR (polymerase chain reaction) device is frequently used. PCR is based on amplifying the genetic material by means of chemical methods upon amplifying and measuring of targeted DNA region (mostly genes). In amplifying of the desired gene part, the target gene part is copied by a very repetitive reaction with the help of Tag DNA polymerase enzyme and bases added to the medium. Thanks to purified DNA polymerases and chemically extended DNA oligo-nucleotides, it is possible that a specially determined DNA array is copied without needing a rapid and living cell. This technique is called “polymerase chain reaction (PCR)”. Thanks to this technique, that DNA part is copied billions of times in an in vitro manner without knowing all of the genome and without needing host cell and only by knowing the desired DNA array. The polymerase chain reaction (PCR) is an in vitro and in vivo DNA amplification method, and the reactions are based on repeating three events, which are at different temperatures, in the form of cycles. DNA parts can be amplified with PCR, and sufficient amount is obtained for sequencing and similar analyses from the samples in nano-gram amount.

PCR is essentially formed by the repetitions of three main cycles: (1) Denaturation, separating of the DNA with double strand to two single strands at 94° C., (2) annealing, binding of primers specifically to the mold DNA in the form of strand at 50-60° C. and (3) extension, amplification of the region, delimited by primers, by Tag DNA polymerase at 72° C.

As a result of repetition of these three steps many times, the targeted DNA part is copied at desired amounts. The devices, which exist already in the market, provide copying of the genetic material by means of repeating the reaction by realizing heating and cooling processes with the help of thermo-electric elements.

Samples are placed to the devices known in the present art, and heating and cooling processes are realized respectively as needed. The cooling process and the heating process for reaching the desired temperature lead to long-lasting of the PCR processes.

In order to realize the exact diagnosis of viral diseases like Covid-19, the genetic material of the virus which leads to the disease is copied in the samples taken from the body of the person who is being tested, and is brought to amounts which can be detected, and PCR method is frequently used in making the detection and in exact realization of the diagnosis and is accepted as the most reliable diagnosis method. However, since the detection of the target genetic material lasts long by realizing sufficient copying and since the sampling capacities of presently used devices are low, usage of alternative systems like rapid test kits, which have low accuracy ratios but which can give more rapid result, is needed.

As a result, because of the abovementioned problems, an improvement is required in the related technical field.

### SUMMARY

The present invention relates to a new PCR device which provides heating of the samples and amplification in short time when compared with the presently used systems and which provides usage of the device with different equipment thanks to the modular structure thereof, for eliminating the abovementioned disadvantages and for bringing new advantages to the related technical field.

An object of the present invention is to provide an alternative system which provides subjecting of the samples to process in an accelerated manner.

Another object of the present invention is to provide an alternative system for the PCR device which will provide simultaneous subjecting high amount of samples, when compared with the presently used devices, to processes.

In order to realize the abovementioned objects and the objects which are to be deducted from the detailed description below, the present invention provides an alternative system for providing subjecting of samples to denaturation, annealing and extension processes in PCR devices. Accordingly, the subject matter PCR device comprises a heating unit carrier comprising at least one first heating unit which provides heating of a first heating region at a first temperature for the denaturation process, at least one second heating unit which provides heating of a second heating region at a second temperature for the annealing process, at least one third heating unit which provides heating of a third heating region at a third temperature for the extension process; wherein said first heating unit, said second heating unit and said third heating unit are arranged in a first circular axis; the subject matter PCR device comprises a sample carrier comprising at least one sample chamber placed in at least one point at a second circular axis which is parallel to said first circular axis; subject matter PCR device further comprises at least one movement mechanism which provides movement of the sample chamber in a manner providing passage of the sample chamber between said first heating region, said second heating region and said third heating region. Thus, by using different heating units for different processes, the need for waiting for cooling and heating is avoided, and the process is accelerated.

The present invention moreover has a modular structure which allows addition/removal of sample transfer systems provided for adding/removing samples, measurement devices between the heating units thanks to the feature of sample chamber which moves between the heating units provided in the first axis. Thanks to this structure, increased number of samples is heated when compared with the present art.

In a possible embodiment of the present invention, in said first circular axis, said heating unit carrier comprises a holding unit which defines a holding region.

In a possible embodiment of the present invention, the heating units comprise a first heating element and a second heating element positioned mutually in a manner defining the heating region.

In another possible embodiment of the present invention, said sample carrier is in the form of a plate, and the heating unit carrier is in the form of a plate placed in a parallel manner to the sample carrier, and the movement mechanism is configured to move the sample carrier and/or heating unit carrier in an axis passing through the center of the sample carrier and/or heating unit carrier.

In another possible embodiment of the present invention, said sample carrier is in cylindrical form or in prism form and said heating unit carrier is in cylindrical form configured to telescopically engage with the sample carrier, and the movement mechanism is configured to move the sample carrier and/or heating unit carrier in an axis passing through the center of the sample carrier and/or heating unit carrier.

In another possible embodiment of the present invention, said sample carrier is in the form of octagonal prism or hexagonal prism, and said heating unit carrier is in the form of a prism configured to telescopically engage with the sample carrier, and the movement mechanism is configured to move the sample carrier and/or heating unit carrier in an axis passing through the center of the sample carrier and/or heating unit carrier.

In another possible embodiment of the present invention, the sample carrier comprises pluralities of sample chambers positioned in said second circular axis.

In another possible embodiment of the present invention, the sample carrier comprises sample chambers provided in equal numbers as the heating units positioned in said second circular axis. Thus, more than one sample can be subjected to processes with different temperatures simultaneously.

In another possible embodiment of the present invention, the sample chambers are arranged in a manner annealing with the radian between the radian sequential heating units between the sequential sample chambers. Thus, the sample which exits a heating unit passes to a next heating unit, and another sample passes to the prior heating unit.

DNA parts can be amplified with PCR and the sufficient amount is obtained for sequencing and similar analyses from the samples in nano-gram amount. Normally, in PCR methods, long amplification duration is needed for obtaining desired amount of DNA. This situation is a disadvantage for obtaining high amount of genetic material. The amount of genetic material to be obtained in short-duration cycles stays at very low amounts. However, by means of the speed advantage which will be presented by the designed system/device, the desired genetic material can be obtained in a very rapid manner and in very high amounts. Moreover, much more amount of samples can be amplified when compared with PCR devices used presently.

### BRIEF DESCRIPTION OF THE DRAWINGS

In FIG. 1, the view of an embodiment of the heating mechanism is given.

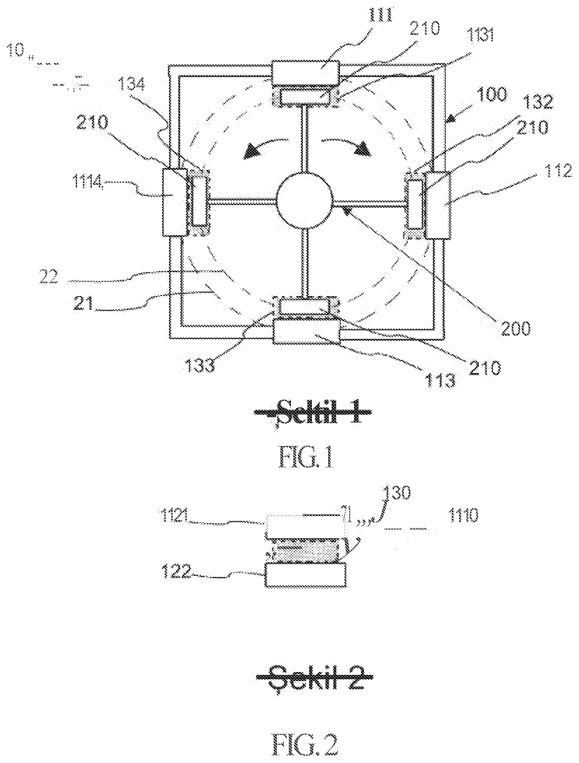

In FIG. 2, a representative cross-sectional view of an embodiment of one of the heating units is given.

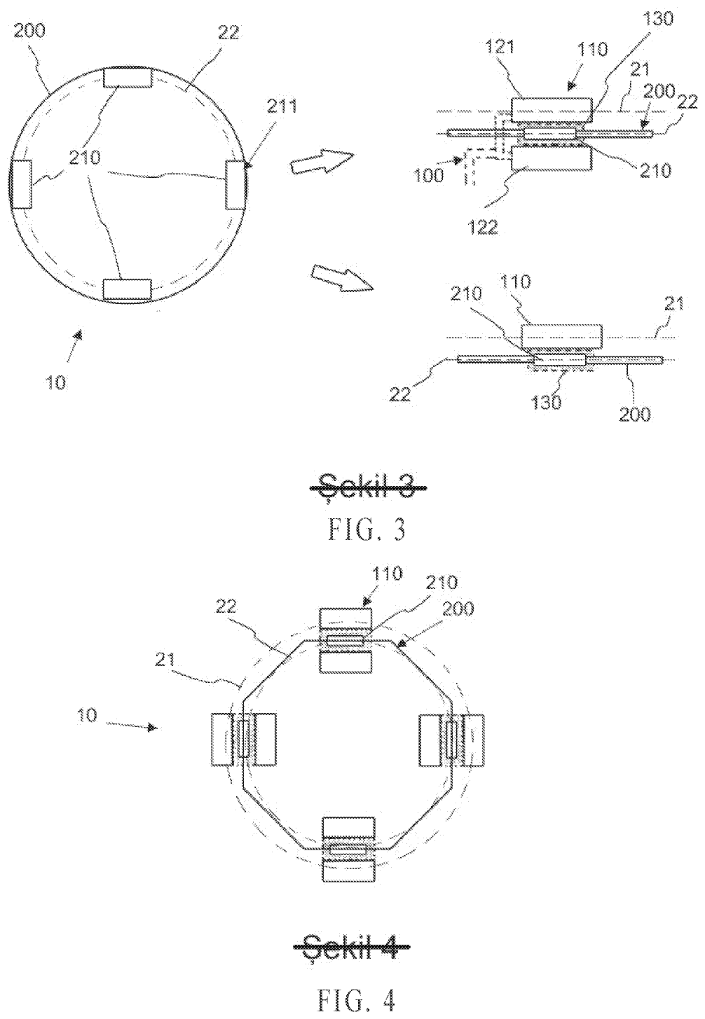

In FIG. 3, a top representative view of the embodiment where the chamber carrier is in plate form and a lateral cross-sectional view where said embodiment comprises heating elements and a lateral cross-sectional view where said embodiment comprises the first heating element and the second heating element of the heating unit are given.

In FIG. 4, a top representative view of the embodiment where the chamber carrier is in octagonal prism form is given.

### DETAILED DESCRIPTION OF THE INVENTION

In this detailed description, the subject matter is explained with references to examples without forming any restrictive effect only in order to make the subject more understandable.

The present invention is a modular heating mechanism (10) which provides the placed samples to be subjected to denaturation, annealing and extension processes, and a PCR device comprising said heating mechanism (10). It essentially provides movement in a circular axis between the heating regions where the heaters, which provide realization of the denaturation, annealing and extension processes, provide heating.

With reference to FIG. 1, the present invention comprises a heating unit carrier and a sample carrier (200). The sample carrier (200) and the heating unit carrier move relatively with respect to each other and provide passage of the sample chambers (210) in the sample carrier (200) between the heating units in the heating unit carrier and provides subjecting to the denaturation, annealing and extension processes. In FIG. 1, the representative view of the heating unit carrier and the chamber carrier is given. The chamber carrier and the heating unit carrier can have any form which can realize the movement which will be defined below.

In more details, the heating unit carrier (100) comprises a first heating unit (111), a second heating unit (112) and a third heating unit (113) arranged in a first axis. In a possible embodiment of the present invention, the heating unit carrier (100) further comprises a holding unit (114). The heating units (110) emit heat for providing subjecting of the samples to denaturation, annealing and extension processes. The holding unit (114) provides keeping and/or holding of the samples in a holding region (134). The first heating unit (111) realizes in a manner that keeping a first heating region (131) at a first temperature. The second heating unit (112) realizes in a manner that keeping a second heating region (132) at a second temperature. The third heating unit (113) realizes in a manner that keeping a third heating region (133) at a third temperature. The heating units (110) can be associated with components like sensors, processors, etc. which control operation. Since the details of the heating units in PCR devices are well known in the related art, these details have not been given here.

The first temperature can be 94 degrees centigrade which is needed for denaturation, and the second temperature can be 50-60 degrees centigrade which is needed for annealing, and the third temperature can be 72 degrees centigrade which is needed for extension.

In a possible embodiment of the present invention, the heating units (110) can comprise a first heating element (121) and a second heating element (122) positioned in a manner defining a heating region in between.

The sample chambers (210) describe the mechanisms where the samples to be processed are placed in PCR device. There is at least one sample chamber (210) in a manner positioned in a second circular axis (22) which is parallel to the first circular axis (21) on the sample carrier (200).

A movement mechanism (not shown in the figures) provides movement of the heating unit carrier and/or chamber carrier in a manner visiting of a first heating region (131), a second heating region (132), a third heating region (133) and a holding region (134) by the sample chamber (210). The movement mechanism can comprise drive elements like motor and can be controlled by drivers.

In a possible embodiment of the present invention, the chamber carrier comprises three sample chambers (210). In a possible embodiment, the chamber carrier also comprises a holding chamber (211) provided for waiting. Said sample chambers (210) are arranged in the second circular axis (22) and are arranged at radians between the heating chambers and the sequential heating units. For instance, the heating units can be arranged at 90 degrees/pi radian intervals. In other words, the center angle through the center of the first circular axis (21) between two sequential heating units is 90 degrees. In other words, three heating units and a holding unit are placed to the first circular axis (21) with equal intervals. In this case, the sample cells are arranged through the center of the second axis such that the center angles in between are 90 degrees, in other words, such that the center angles in between are 90 degrees/pi radians. While a heating sample is in a heating region, all other sample chambers (210) are positioned in the remaining heating regions. Thus, the four samples are subjected to denaturation, annealing and extension processes simultaneously by using only three heating units.

With reference to FIG. 3, the chamber carrier is provided in plate form, preferably in circular plate form. The chamber carrier can realize its movement by rotating in an axis which passes through the center thereof and which is orthogonal to the plane where the plate extends. In this possible embodiment, the heating unit carrier can also be in plate form and can be positioned in a parallel manner to the chamber carrier. In this possible embodiment, the heating unit carrier can comprise two bodies in plate form in a manner facing two faces of the chamber carrier, and the first heating element (121) and the second heating element (122) of the heating units can be positioned at these plates. In the form given above, only the chamber carrier has been given, and the heating unit carrier and the axes have also been shown in a representative manner in the lateral views.

With reference to FIG. 4, in a possible embodiment of the present invention, the chamber carrier can be in cylindrical or octagonal prism or hexagonal prism form. The heating unit carrier (100) can be provided in a manner telescopically engaging with the chamber carrier. One of the heating unit carrier (100) or the sample carrier (200) can rotate at an axis which passes through the centers thereof. In this manner, only the representative view of the chamber carrier is given and the heating unit carrier can be configured in a fixed or movable manner in a compliant manner.

The operation of the invention whose details are given above can be realized as given below. A sample is placed to one of the sample chambers (210). The chamber carrier or the heating unit carrier is moved such that the sample arrives at the first heating region (131). After a predetermined duration, the sample is placed to the sample chamber (210) which is positioned after the full sample chamber (210), and the heating unit carrier or the chamber carrier is moved such that the recently filled sample chamber (210) comes to the first heating region (131). In this arrangement, the other chambers are respectively filled, and when the firstly filled sample chamber (210) exits the third heating unit (113), said firstly filled sample chamber (210) can come to the first heating region (131) again, and thus, the cycle can be repeated at a desired number of times.

One of the sample carrier (200) and the heating unit carrier can be movable and other one can be fixed. While the movable one can have a body formed by cylindrical plate or arms, and the other one can be fixed to the body of the PCR device by means of various arms.

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

### REFERENCE NUMBERS

10 Heating mechanism
100 Heating unit carrier
110 Heating unit
111 First heating unit
112 Second heating unit
113 Third heating unit
114 Holding unit
121 First heating element
122 Second heating element
130 Heating region
131 First heating region
132 Second heating region
133 Third heating region
134 Holding region
200 Sample carrier
210 Sample chamber
211 Holding chamber
21 First circular axis
22 Second circular axis

What is claimed is:

1. A PCR device comprising a heating mechanism for subjecting samples to denaturation, annealing and extension processes, wherein the subject matter PCR device comprises:
a heating unit carrier comprising:
at least one first heating unit which provides heating of a first heating region at a first temperature for the denaturation process,
at least one second heating unit which provides heating of a second heating region at a second temperature for the annealing process,
at least one third heating unit which provides heating of a third heating region at a third temperature for the extension process;
wherein said first heating unit, said second heating unit and said third heating unit are arranged in a first circular axis; and
the PCR device comprises a sample carrier comprising at least one sample chamber placed in at least one point at a second circular axis which is parallel to said first circular axis; and
the PCR device further comprises at least one movement mechanism which provides movement of the sample chamber between said first heating region, said second heating region and said third heating region.

2. The PCR device according to claim 1, wherein said heating unit carrier further comprises a holding unit provided in said first circular axis and which defines a holding region.

3. The PCR device according to claim 1, wherein the first heating unit, the second heating unit, and the third heating unit all comprise a first heating element and a second heating element positioned to define a heating region in between said first heating element and said second heating element.

4. The PCR device according to claim 1, wherein said sample carrier is in a plate form, and the heating unit carrier is in the plate form placed in a parallel manner to the sample carrier, and the movement mechanism is configured to move the sample carrier and/or heating unit carrier in an axis passing through the center of the sample carrier and/or heating unit carrier.

5. The PCR device according to claim 1, wherein said sample carrier is in cylindrical form, and said heating unit carrier is configured to telescopically engage with the sample carrier, and the movement mechanism is configured to move the sample carrier and/or heating unit carrier in an axis passing through the center of the sample carrier and/or heating unit carrier.

6. The PCR device according to claim 1, wherein said sample carrier is in hexagonal or octagonal prism form, and said heating unit carrier is in the form of a prism configured to telescopically engage with the sample carrier, and the movement mechanism is configured to move the sample carrier and/or heating unit carrier in an axis passing through the center of the sample carrier and/or heating unit carrier.

7. The PCR device according to claim 1, wherein the sample carrier comprises a plurality of sample chambers positioned in said second circular axis).

8. The PCR device according to claim 6, wherein the sample carrier comprises a plurality of sample chambers provided in the same number as the first heating unit, the second heating unit, and the third heating unit positioned in said second circular axis.

9. The PCR device according to claim 6, wherein a plurality of sample chambers are arranged in a manner annealing with the radian between the radian sequential heating units between the sequential sample chambers.

10. The PCR device according to claim 7, wherein the plurality of sample chambers are arranged in a manner annealing with the radian between the radian sequential heating units between the sequential sample chambers.
